(19) United States
(12) Patent Application Publication
(10) Pub. No.: US 2013/0053117 A1
(43) Pub. Date: Feb. 28, 2013

(54) Six-Card Poker Game

(71) Applicant: Roger Snow, Las Vegas, NV (US)

(72) Inventor: Roger Snow, Las Vegas, NV (US)

(73) Assignee: Shuffle Master, Inc., Las Vegas, NV (US)

(21) Appl. No.: 13/215,156

(22) Filed: Aug. 22, 2011

(51) Int. Cl. G06F 17/00; A63F 1/00

(52) U.S. Cl. 463/12; 273/303

(57) ABSTRACT

A poker card game in which a dealer deals six cards to a player and six cards to the dealer. Three of the dealer's cards are exposed. The player may fold or continue with a play wager. Preferably, the play wager is 1× the ante wager. The dealer reveals the dealer's best five-card poker hand formed from any of the dealer's six cards, and the player reveals the player's best five-card poker hand formed from any of the player's six cards. The highest ranking hand wins. Preferably pays even money. Preferably, the dealer must qualify with an ace-king. Preferably allows a side wager that pays according to a pay table. Preferably played with one deck of cards. Includes card game method, device-readable storage medium containing device-executable code, and device-executable code stored on a device-readable storage medium.

### BACKGROUND

1. Field

In general, the inventive arrangements relate to card play, and more specifically, to a poker variety thereof.

2. Description of Related Art

For illustrative, exemplary, representative, and non-limiting purposes, one preferred embodiment of the inventive arrangements will be described in terms of live card play at a casino. However, the inventive arrangements are not limited in this regard.

Card games are well known. Many varieties exist, including for one or more of entertainment, leisure, recreation, gaming, gambling, and/or the like. One popular variety is poker, in which players compete against other players and/or a dealer in an attempt to obtain a best hand that outranks other hands according to hand rankings, such as the following ascending hierarchy for a typical five-card poker game:
High Card
One Pair
Two Pair
Three-of-a-Kind
Straight
Flush
Full House
Four-of-a-Kind
Straight Flush
Royal Flush

Within this hierarchy, whichever participant holds a highest ranking hand at the end of play wins that particular hand, round, game, match, tournament, and/or the like. Poker is a well-liked and often-played game enjoyed by millions of people around the world, perhaps because it invokes a unique combination of, inter alia, skill, luck, risk-reward strategies, and/or psychology.

Oftentimes, wagers regarding a probability, likelihood, chance, hazard, and/or randomness that a certain event or happening may, or may not, occur can enhance game play and/or participation. They can be placed prior to game play and during game play. They can refer to a main activity or action in a game, to a propositional, side, and/or other alternative activity or action, and/or other. They may be monetary, non-monetary, and/or other. They can be expressed in cash, currency, coin, gaming chips, player credit, card swipe, and/or other. And they can help establish an understanding, agreement, and/or contract by which parties maintain that a certain sum of money, or other, may, or will, be exchanged between them, particularly upon the occurrence, or non-occurrence, of an activity not otherwise known a priori between the parties.

Many variations of poker games exist. An inventive variation will now be described.

### SUMMARY

In game play, a dealer receives an ante wager from a player seeking to participate in the game. The dealer then deals six cards to the player, as well as six cards to the dealer. Three of the dealer's six cards are exposed to the player. Based, at least in part, on the player's assessment of the dealer's three exposed cards and/or the player's six cards, the player may either i) fold or ii) place a play wager if the player desires to continue play. If the player placed a play wager to continue play, then the dealer reveals the dealer's best five-card poker hand formed from any of the dealer's six cards. Likewise, the player reveals the player's best five-card poker hand formed from any of the player's six cards. Whichever participant holds a highest ranking hand at the end of play wins. Other rules and/or permutations are implemented as well.

In one embodiment, the inventive arrangements are implemented as a table game for one or more players and a live dealer.

In another, or the same, embodiment, at least part of the inventive arrangements are implemented as programming instructions at an electronic, or at least partially electronic, table game for one or more players and a live dealer.

In yet other or the same embodiments, at least part of the inventive arrangements are implemented as programming instructions at a video device for one or more players and a virtual dealer.

In yet still other or the same embodiments, at least part of the inventive arrangements are implemented as programming instructions at a gaming device for an individual player.

In further or the same embodiments, at least part of the inventive arrangements are carried out over a communications network.

In additional or the same embodiments, at least part of the inventive arrangements are carried out over a computer network.

### BRIEF DESCRIPTION OF SEVERAL VIEWS OF THE DRAWINGS

A clear conception of the advantages and features constituting inventive arrangements, and of various construction and operational aspects of typical mechanisms enabling such arrangements, are readily apparent by referring to the following illustrative, exemplary, representative, and non-limiting figures, which form an integral part of this specification, in which like numerals generally designate the same elements in the several views, and in which:

FIG. 1 illustrates a representative odds table for a side wager implemented with the inventive arrangements;

FIG. 2 is a top view of a preferred table game arrangement for implementing at least part of the inventive arrangements as a table game for one or more players and a live dealer;

FIG. 3 is a top view of a preferred table game layout for implementing at least part of the inventive arrangements as a table game for one or more players and a live dealer;

FIG. 4 illustrates a close-up of a player position from the table game layout of FIG. 3;

FIG. 5 is a top view of a preferred table game arrangement for implementing at least part of the inventive arrangements at an electronic, or at least partially electronic, table game for one or more players and a live dealer;

FIG. 6 is a perspective view of a video machine for implementing at least part of the inventive arrangements at a video device for one or more players and a virtual dealer;

FIG. 7 is a perspective view of a video machine for implementing at least part of the inventive arrangements at a gaming device for an individual player;

FIG. 8 is a simplified schematic view of a gaming network in which at least part of the inventive arrangements are carried out over a computer network;

FIG. 9 is a simplified schematic view of the computer system of FIG. 8; and

FIG. 10 is a functional block diagram of at least part of the inventive arrangements.

### DETAILED DESCRIPTION OF PREFERRED EMBODIMENTS

Referring now to the figures, several preferred embodiments of the inventive arrangements are described in terms of card play at a casino. However, the inventive arrangements are not limited in this regard. For example, while one preferred embodiment provides a set of rules for live game play in a casino context, other contexts are also hereby contemplated and disclosed, including various other applications and/or executions of the rules of play.

As a preliminary matter, a complete set of cards is often referred to as a deck, or pack, of cards, and a subset thereof, particularly as held by a player during game play, is often referred to as a hand. In general, one face of each card usually carries card markings (e.g., ranks and suits) that distinguish it from other cards in the deck, while a back thereof is usually identical for all of the cards in the deck (e.g., often artistically styled with one or more colors and/or designs).

Now then, the inventive arrangements preferably use one standardized 52 card poker deck. In alternative embodiments, multiple decks are used. In the same or other embodiments, wild cards, jokers, and/or the like are also used. Preferably, the cards are shuffled a priori, preferably by a shuffler or shuffling apparatus. Ideally, this randomizes all of the cards before game play begins, thereby generating a random permutation of card orderings for non-biased card play. In one embodiment, the cards are physical playing cards. In other alternative embodiments, the cards are virtual playing cards.

Rules of play will now be described.

In order to participate in the game, a dealer receives an ante wager from a player, which is a set amount tendered by every player prior to cards being dealt. Once a player has offered an ante wager to the dealer and the dealer has received and accepted same, card play begins, notably with the dealer dealing an entire hand of six cards, all face down, to the player. Likewise, the dealer deals an entire hand of six cards to the dealer as well. Preferably, the dealer's six cards are also dealt face down to the dealer, after which the dealer exposes three of the dealer's six cards face up, thereby revealing these three cards to the player and to the dealer. Preferably, the dealer's three exposed cards are the last three cards dealt to the dealer. Alternatively, three of the dealer's cards are dealt face up ab initio, or in an otherwise alternating fashion, and/or otherwise, whereby one-half of the dealer's hand, namely three of the dealer's six cards, is exposed during play. Preferably, the cards are first dealt to the player and then to the dealer, or alternatively, first to the dealer and then to player, and/or in an otherwise alternating fashion between the player and the dealer.

With the player now able to view the player's entire hand, namely all six of the player's cards, as well as three of the dealer's six cards, the player has a choice to make. Based, at least in part, on the player's individual assessment of the player's hand and/or the dealer's likely final hand, the player may choose to fold the player's hand, in which case the player's ante wager is forfeited and surrendered to the dealer and play discontinues for that player for that match-up. The player's decision is personal to that player. It may be based on subjective factors, objective factors, both, or other. The player's goal is to beat the dealer's hand according to which hand will likely have a highest hand ranking according to standard five-card poker hand rankings. Alternatively, based, again at least in part, on the player's individual assessment of the player's hand and/or the dealer's likely final hand, the player may instead choose to continue play, in which case the player makes an additional wager, called a play wager, in order to be able to stay in the game and continue to participate and play. Preferably, the player's play wager is based on the player's ante wager. For example, the play wager is preferably equal to the ante wager. Alternatively, the player's play wager is a multiple of one or more times the player's ante wager.

If, and after, a player places a play wager, both the dealer and player make their best five-card poker hands from their respective six-card hands. There are no community or shared cards between the player and dealer, and the dealer's best five-card hand includes as many of the dealer's three exposed cards as the dealer desires in order to make the dealer's best five-card poker hand. For example, since the dealer needs five cards to make the dealer's best five-card poker hand, the dealer's hand may include either two or three of the dealer's three exposed cards. The dealer cannot use zero of the dealer's three exposed cards, as that would only enable the dealer to form a three-card hand—namely, with the dealer's three unexposed cards. Likewise, the dealer cannot use only one of the dealer's three exposed cards, as that would only enable the dealer to form a four-card hand—namely, with the dealer's three unexposed cards and only one of the dealer's exposed cards. Thus, the dealer must include two or three of the dealer's three exposed cards when making the dealer's best five-card poker hand. At or about the same time, the player also uses any of the player's six cards to form the player's best five-card poker hand.

In this dealer verses player match-up, whoever holds a highest ranking hand at the end of play wins. In other words, if the dealer's best five-card poker hand outranks the player's best five-card poker hand according to standard five-card poker hand rankings, then the dealer wins. If the dealer wins, then the dealer preferably keeps the player's ante wager and the player's play wager. Alternatively, if the player's best five-card poker hand outranks the dealer's best five-card poker hand according to standard five-card poker hand rankings, then the player wins. If the player wins, then the player is preferably rewarded even money on both the player's ante wager and the player's play wager.

In the same and/or other alternative embodiments, if neither the dealer's best five-card poker hand outranks the player's best five-card poker hand or the player's best five-card poker hand outranks the dealer's best five-card poker hand—in other words, the hands tie—then the dealer preferably returns the player's ante wager and/or play wager to the player. Alternatively, in one embodiment, the player wins in the event of a tie with the dealer. Alternatively, in another embodiment, the dealer wins in the event of a tie with the player.

In the same and/or other alternative embodiments, the dealer's hand must qualify for play, for example with an ace-king hand. In other words, if the dealer's best five-card poker hand does not contain at least one ace of any suit and at least one king of any suit, then the dealer has failed to qualify and returns the player's ante wager to the player (i.e., the dealer returns or pushes the player's ante wager back to the player). In this instance, the play wager continues. In the same and/or other alternative embodiments, if the dealer's best five-card poker hand does not contain at least one ace of any suit and at least one king of any suit, then the dealer loses.

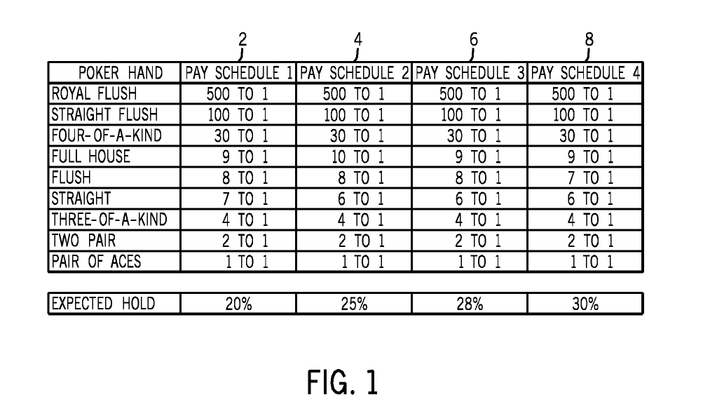

In the same and/or other alternative embodiments, an optional or mandatory side wager is also offered to the player. More specifically, the player tenders, and the dealer accepts, a side wager from the player, preferably at the same time, or shortly after, the ante wager is received to initiate play. Preferably, the side wager is tendered before any cards are dealt, including dealing any and all cards to the player and to the dealer. Preferably, the side wager is paid according to a pay table, and it is preferably independent of the dealer's best five-card poker hand and/or the player's best five-card poker hand. In other words, the dealer preferably pays the side-wager payout according to the pay table regardless of whether i) the player folds, ii) the dealer qualifies, iii) the player's best five-card poker hand beats the dealer's best five-card poker hand, iv) the dealer's best five-card poker hand beats the player's best five-card poker hand; and/or v) the player and dealer tie. A preferred side wager pays out if, and anytime, the player receives at least a pair of aces or better. Four representative odds schedules are depicted in FIG. 1, all of which convey different side-wager payout odds based on different poker hands and yield different expected holds, any or all of which (or other) is implemented as needed and/or desired in various preferred embodiments.

The rules of game play have been described according to preferred embodiments. In at least one embodiment, these rules are taught to a dealer administering the game. In the same and/or other alternative embodiments, this set of instructions for game play is preferably implemented and/or executed as one or more of at least the following:

a table game for one or more players and a live dealer;

programming instructions at an electronic, or at least partially electronic, table game for one or more players and a live dealer;

programming instructions implemented at a video device for one or more players and a virtual dealer;

programming instructions implemented at a gaming device for an individual player;

programming instructions carried out over a communications network; and/or

programming instructions carried out over a computer network.

Each of these game play implementations, and more, is contemplated by, and configurable according to, the inventive arrangements.

In summary fashion, each will also now be described.

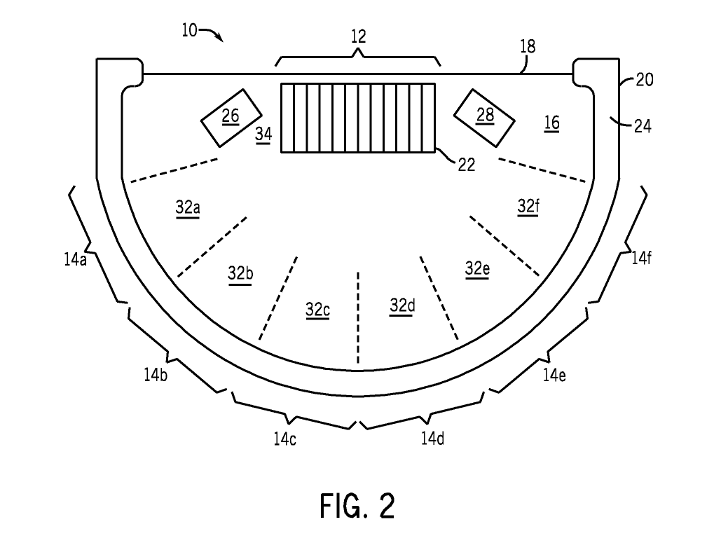

Referring now to FIG. 2, the inventive arrangements are, in one embodiment, preferably implemented as a table game, such as, for example, in a casino, hall, casino hall, hotel, hotel room, casino hotel, race track, racino, gambling hall, gaming hall, parlor, card room, lounge, lobby, studio, conference facility, convention facility, auditorium, gymnasium, school, store, convenience store, grocery store, gas station, mall, strip mall, midway, cruise ship, floating vessel, flying vessel, and/or the like (none shown)—using physical playing cards (not shown). More specifically, the game method is implemented on a physical table 10, in which a dealer position 12 for a dealer (dealer not shown) is in generally opposite relation to one or more player positions 14 for players (players not shown). In one preferred embodiment, six player positions 14a-14f are provided.

More specifically, and as is typical of structural components of gaming tables in the industry, at least a top surface 16 of the table 10 is, in a preferred form, generally semi-circular in nature and/or shape, with the dealer position 12 being generally proximate to, and central of, a generally straight edge 18 thereof, and the player positions 14 being generally disposed in side-by-side arrangements proximate to, and adjacent of, a generally arcuate edge 20 thereof. Preferably, the top surface 16 is generally horizontal with respect to a floor (not shown) on which the table 10 rests.

As may vary with a desired table configuration, the dealer position 12 is partly or wholly padded (none shown) along the straight edge 18 of the top surface 16 of the table 10. Preferably, a chip rack 22 is also supported by the top surface 16 of the table 10 and proximate to the dealer position 12, particularly for holding and/or storing physical poker chips (not shown) and/or the like during game play. Commonly, a player armrest and/or perimeter pad 24 extends about the arcuate edge 20 of the top surface 16 of the table 10, generally along the player positions 14 and outwardly facing the players. Particularly to initiate and during game play, one or more players generally sit or stand along the arcuate edge 20 of the top surface 16 of the table 10, thereby occupying a player position 14 and engaging the dealer from the dealer position 12.

In addition, a preferred table 10 is also configured to accommodate one or more of a card shuffler 26 and/or a card shoe 28. Both are also representatively depicted. For example, in the same and/or alternative embodiments, both are located on, adjacent to, and/or otherwise proximate to the top surface 16 of the table 10, particularly located to facilitate game play from the dealer position 12. In various embodiments, the card shuffler 26 may be a batch shuffler, continuous shuffler, and/or other, including various types of physical and/or mechanical shufflers used to randomize cards and/or card orderings. In various embodiments, the card shuffler 26 may be single deck and/or multiple deck shuffler. In various embodiments, the card shuffler 26 and card shoe 28 may be one-in-the-same or different devices. In various embodiments, one or both of the shuffle 26 and card shoe 28 may include one or more of card recognition capabilities, card counting capabilities, card recalling capabilities, hand-forming capabilities, and/or the like. Other variations are also contemplated. For example, in a preferred virtual embodiment (described in additional detail below), the card shuffler 26 is preferably implemented as a random number generator, while the inventive arrangements are, in various other embodiments, also implemented by manually shuffling and/or dealing playing cards by hand as well.

Referring to FIGS. 1 through 4, one preferred way to implement the inventive methods on the table 10 is to include a layout 30 on the top surface 16 of the table 10. More specifically, the layout 30 preferably delineates one or more of the player positions 14, each of which includes a respective player area 32 for each player. In summary fashion, each player area 32 provides and/or defines an individual playing space for each player during game play. This layout 30 also delineates the dealer position 12, including a dealer area 34 for the dealer. As such, the layout 30 is configured to facilitate game play on the table 10. For example, when played with physical poker chips, a first player spot 36 is preferably provided for each player to provide that player's ante wager. A second player spot 38 is preferably provided for each player to provide that player's play wager, assuming, that is, that a player has decided to continue play after that player has assessed the player's hand and/or the dealer's likely hand after all cards have been dealt and three of the dealer's six cards have been exposed. Preferably, additional gaming instructions are also communicated at, within, and/or proximate to, the player area 32, such as, for example, informing and/or reminding a player that the player's play wager is preferably one times the player's ante wager. Preferably, such additional gaming instructions are provided at, within, and/or proximate to the second player spot 38. Preferably, additional gaming instructions are also communicated at, within, and/or proximate to a banner 40 carried on the layout 30, such as, for example, informing and/or reminding a player that the dealer must qualify with a particular hand or otherwise the dealer will push the player's ante wager back to the player. Preferably, six dealer card locations 46a-46f are also provided on the layout 30, which provide individual locations for the dealer's six cards of play within the dealer area 34. Preferably, three dealer card locations 46a-46c are reserved and/or otherwise marked for the dealer's three cards that are exposed face up during game play.

When the gaming method is offered with an additional optional or mandatory side wager from the player, a third player spot 48 is also preferably provided for each player to provide that player's side wager. Preferably, additional gaming instructions are also provided at, within, and/or proximate to the third player spot 48, such as, for example, informing and/or reminding a player of a side-wager qualification minimum. Preferably, the layout 30 also conveys an odds table 4, such as from FIG. 1, at, within, and/or proximate to the player area 32, which is used to indicate different side-wager payout odds based on different poker hands formed during active play.

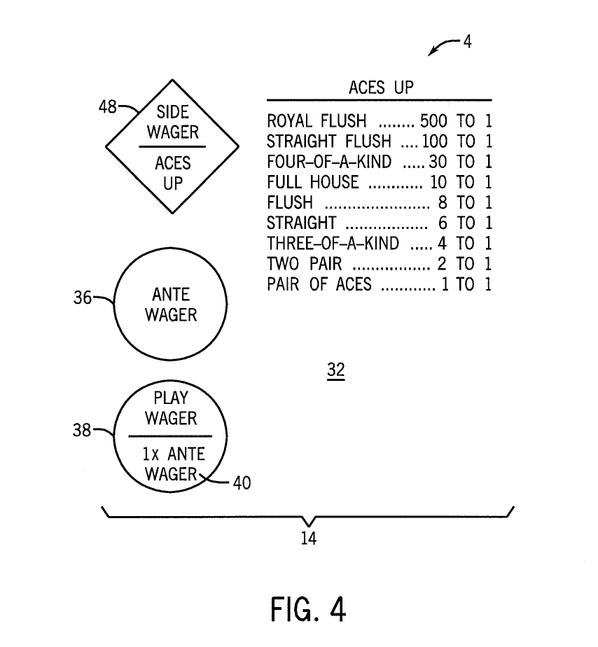

In representative fashion, FIG. 4 individually depicts a single player position 14 from the layout 30 on the top surface 16 the table 10, including the respective player area 32 for the player and also including i) the first player spot 36 for the player to place the player's ante wager to begin game play; ii) the second player spot 38 for the player to place the player's play wager, such as one times the player's ante wager, if the player desires to continue play; iii) the third player spot 48 for the player to place the player's side wager, if any; and iv) an odds table 4 or different side-wager payout odds.

As described, the inventive arrangements describe a method of card play on a physical table 10. Commonly, ante wagers, play wagers, and/or side wagers are placed using physical poker chips, which the dealer preferably banks through the chip rack 22. In one preferred embodiment, the player tenders such wagers through one or more of the first player spot 36, second player spot 38, and/or third player spot 48, namely by placing the physical poker chips thereupon the top surface 16 of the table 10.

In another alternative embodiment, the player tenders such wagers electronically, including at a chipless table 10′. More specifically, as will now be elaborated upon, wagering at a chipless table 10′ is preferably based on a player's credit instead of a player's physical poker chips.

In the industry, game profitability is influenced by the speed at which dealers and players play games. Gaming platforms are thus commonly designed to address and/or accommodate at least some or all of the following: increasing the speed of play, including the speed of wagering; decreasing and/or altogether eliminating payout errors; facilitating cash-ins and cash-outs; preventing cheating; and/or preventing dealers from colluding with players. A chipless table 10′ address such concerns.

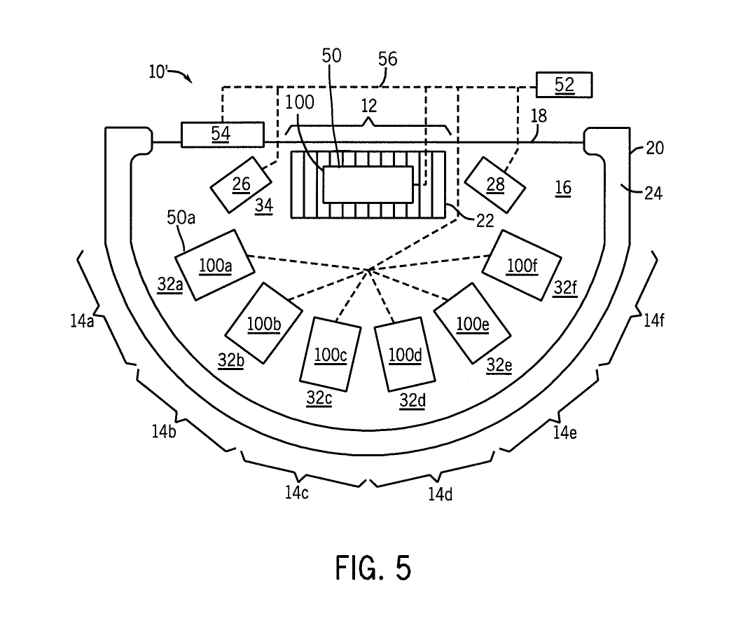

More specifically, and referring now to FIG. 5, the top surface 16 of the chipless table 10′ still preferably supports a chip rack 22, but namely to facilitate players cashing in and cashing out of game play. As mentioned, wagering at the chipless table 10′ is preferably based on the player's credit instead of the player's physical poker chips. Commonly, credit is first registered when the player approaches the chipless table 10′ and desires to play—often by exchanging physical poker chips and/or tickets, tokens, coins, cash, currency, credits, cards, player accounts, mercantile exchange, and/or the like for an electronic credit. Preferably, the dealer banks the player's physical poker chips (if provided) at or in the chip rack 22 (or other). In any event, when the player discontinues play, the process is reversed—namely, the electronic credit, if any, is exchanged for poker chips (if provided) from the chip rack 22 (or other). In the interim, however, the player's collateral is preferably wagered, bartered, tracked, and/or monitored electronically.

Even more specifically, the top surface 16 of the chipless table 10′ preferably supports a display/input interface 100 at each player area 32 for each player position 14. Preferably, the player's display/input interface 100 is flush mounted with the top surface 16 of the table 10.

Likewise, the top surface 16 of the chipless table 10′ also preferably supports a display/input interface 100 at the dealer area 34 for the dealer position 12. Preferably, the dealer's display/input interface 100 is intermediate the chip rack 22.

Preferably, common display/input interfaces 100 include one or more of the following in various embodiments: analog screens, cathode ray tube (CRT) screens, digital screens, light-emitting diode (LED) screens, liquid-crystal diode (LCD) screens, plasma screens, and/or the like, as well as one or more of single screens, dual screens, triple screens, split screens, segment screens, picture-in-picture screens, holographic screens, virtual screens, two-dimensional screens, three-dimensional screens, and/or the like.

Preferably, each display/input interface 100 also includes a data entry input 50, such as a touch-screen data entry surface. In various embodiments, they react to one or more of pressure, heat, moisture, and/or other conductivity measures, and/or the like.

The display/input interface 100 and data entry input 50 enable the player and/or dealer to participate in the game by communicating at least some instructions electronically through the display/input interface 100 and/or data entry input 50. For example, when a player approaches the chipless table 10′ and desires to play, the player exchanges physical poker chips (or other) for an electronic credit, executed through the display/input interface 100 and/or data entry input 50. The underlying card game then proceeds according to the previously-described rules of play, with game play decisions and/or wagering continuing through the display/input interface 100 and/or data entry input 50, e.g., placing and receiving ante wagers, play wagers, and/or side wagers; closing wagers; deciding whether and when to fold; providing visual communications and/or instructions to the player and/or dealer; concluding play; indicating game outcome information; resolving wagers; concluding play; indicating trending information; etc. Preferably, wagers are resolved automatically by adding and/or subtracting, as appropriate, to corresponding player accounts, again preferably through the display/input interface 100 and/or data entry input 50. Finally, when the player discontinues play, the player exchanges the electronic credit, if any, for physical poker chips (or other), again executed through the display/input interface 100 and/or data entry input 50.

In the same and/or other alternative embodiments, physical card play through the card shuffler 26 and/or card shoe 28 on the chipless table 10′ is additionally and/or alternatively replaced with virtual card play, again through the display/input interface 100 and/or data entry input 50.

Preferably, the display/input interface 100 and data entry input 50 are controlled by a control processor 52, preferably located internally within, or otherwise proximate to, the chipless table 10′. In alternative embodiments, the control processor 52 is located elsewhere in a gaming pit and/or location remote from the gaming pit, as needed and/or desired in a particular implementation. In any event, the control processor 52 is programmed, by known techniques, to implement the previously-described rules of play at the chipless table 10′. As such, the control processor 52 interacts and communicates with the display/input interface 100 and data entry input 50, wherein up-dated game and/or wagering information is communicated to the player and dealer as game play advances, particularly at the player area 32 and dealer area 34 of the chipless table 10′.

Preferably, each display/input interface 100 contains its own control processor (not shown) to control same, particularly in communication with the control processor 52. For example, the former preferably administers graphics for display on the display/input interface 100, while the latter preferably administers other game events and/or happenings. In various embodiments, relations therebetween are preferably peer-to-peer; master-slave; client-server; thin-client systems; blended and/or hybrid systems; and/or the like.

Preferably, the control processor 52 also interacts and communicates with one or both of the card shuffler 26 and/or card shoe 28.

Preferably, the control processor 52 also interacts and communicates with a game display 54, which communicates relevant game events and/or happenings, e.g., a game name; rules of play; player status; dealer status; game status; win and loss information; trending information; the odds table 46; hand counts; time of day; etc. In different embodiments, the game display 54 is preferably a one-sided or two-sided display, displaying the same or different information on opposing sides thereof. Preferably, the game display 54 is pole-mounted above the top surface 16 of the chipless table 10′ for ease of viewing.

Preferably, one or more of the card shuffler 26, card shoe 28, display/input interface 100, data entry input 50, control processor 52, and/or game display 54 communicate through a wired, partially wired, and/or wireless communications network 56. Preferably, communication is not limited to electric and/or electronic communications over the communications network 56, but, in various embodiments, it also extends to one or more of optical, audio, and/or magnetic communications networks 56 as well, and/or the like. In a preferred layered construction embodiment, at least part or all of the communications network 56 is embedded on or near the top surface 16 of the chipless table 10′, such as underneath the layout 30.

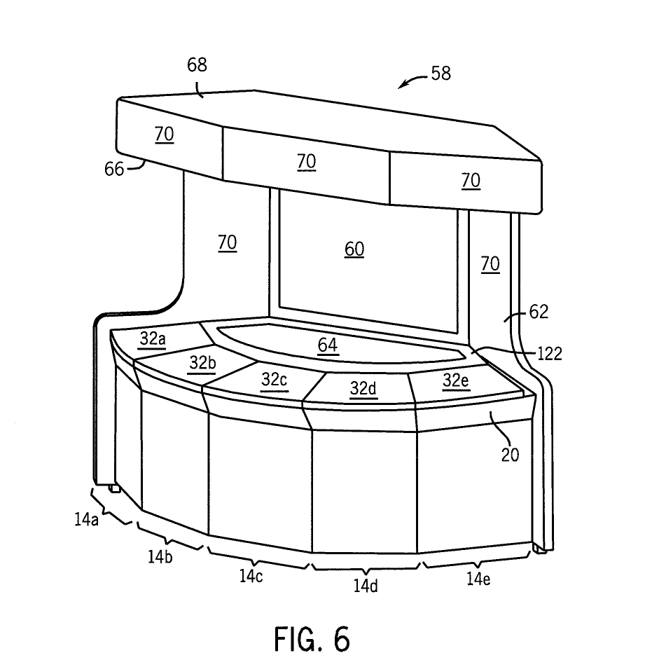

Referring now to FIG. 6, the inventive arrangements are also carried out, in various embodiments, at an electronic, or at least partially electronic, table game for one or more players and a virtual dealer. More specifically, the player positions 14 are arranged in a bank about an arcuate edge 20 of a video device 58. In essence, at least portions of the video device 58 serve as the table 10 from the previous embodiments, in which the player positions 14 include the player area 32 for interacting with the video device 58. The functionality of the display/input interface 100 and data entry input 50 is again brought to the player area 32, preferably by the control processor 52, preferably located internally within, or otherwise proximate to, the video device 58. As previously described, the control processor 52 is again programmed, by known techniques, to implement the previously-described rules of play at the video device 58. As such, the control processor 52 interacts and communicates with the display/input interface 100 and data entry input 50, wherein up-dated game and/or wagering information is communicated to the player as game play advances, particularly at the player area 32 of the video device 58.

Now then, whereas the previously-described table 10 preferably included live card play with a live dealer, the video device 58 instead includes a virtual dealer depicted on a dealer screen 60 (dealer not shown), preferably positioned for forward viewing by at least a player in a player position 14. Preferably, the dealer screen 60 displays a video simulation of the dealer, i.e., a virtual dealer, for interacting with the video device 58, preferably through processing one or more stored programs to implement the previously-described rules of play at the video device 58. Preferably, the dealer screen 60 is carried by a generally vertically depending cabinet 62 of the video device 58.

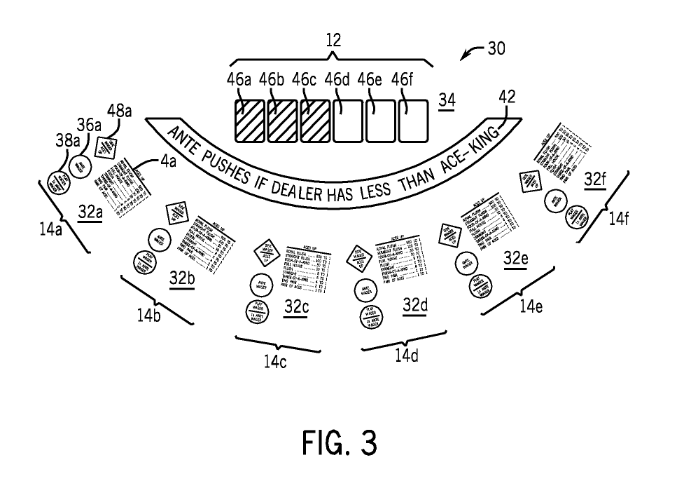

Preferably, the video device 58 also includes a card screen 64, in which at least one or more of the dealer's cards and/or player's cards are displayed as dealt by the virtual dealer. For example, in a preferred embodiment, the card screen 64 preferably displays the dealer's cards, preferably including the dealer card locations 46a-46f (FIG. 3) from the dealer area 34 of the table 10 at the video device 58.

Preferably, the player area 32 is configured for wagering and game play interactions with the video device 58 and/or virtual dealer. To further enhance the experience, additional decorative lights (not shown) are provided in various embodiments, as are speakers (not shown) for transmitting and/or receiving sounds during game play, the latter preferably on an underside surface 66, for example, of a generally horizontally depending top 68 of the cabinet 62 of the video device 58 generally extending towards the player positions 14. As with the layout 30 on the top surface 16 of the table 10, banners 40 again communicate rules of play and/or the like, preferably along one or more walls 70 or the like of the cabinet 62 of the video device 58. Accordingly, game play is preferably accommodated without involving physical playing cards, poker chips, and/or live personnel. The action is instead simulated by the control processor 52 interacting with and controlling the video device 58.

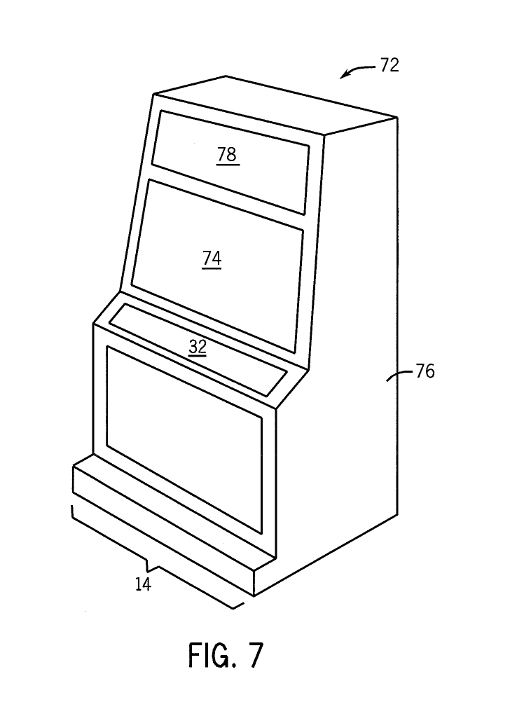

Referring now to FIG. 7, the inventive arrangements are also carried out as a video poker game for an individual player. More specifically, a player position 14 is arranged about a gaming device 72 configured for individual play. Again, the player position 14 includes a player area 32 for interacting with the gaming device 72. The functionality of the display/input interface 100 and data entry input 50 is again brought to the player area 32, again preferably by the control processor 52, preferably located internally within, or otherwise proximate to, the gaming device 72. As previously described, the control processor 52 is again programmed, by known techniques, to implement the previously-described rules of play at the gaming device 72. As such, the control processor 52 again interacts and communicates with the display/input interface 100 and data entry input 50, wherein up-dated game and/or wagering information is communicated to the player as game play advances, particularly at the player area 32 of the gaming device 72.

Now then, the gaming device 72 preferably includes a gaming screen 74, preferably positioned for forward viewing by at least a player in a player position 14. Preferably, the gaming screen 74 displays indicia for interacting with the gaming device 72, preferably through processing one or more stored programs to implement the previously-described rules of play at the gaming device 72. Preferably, the gaming screen 74 is carried by a generally vertically depending cabinet 76 of the gaming device 72.

Preferably, the player area 32 is configured for wagering and game play interactions with the gaming device 72. To further enhance the experience, additional decorative lights (not shown) are provided in various embodiments, as are speakers (not shown) for transmitting and/or receiving sounds during game play. As with the layout 30 on the top surface 16 of the table 10, banners 40 again communicate rules of play and/or the like, preferably along a top portion 78 or the like of the cabinet 76 of the gaming device 72. Accordingly, game play is accommodated without involving physical playing cards, poker chips, and/or live personnel. The action is instead simulated by the control processor 52 interacting with and controlling the gaming device 72.

While the gaming device 72 is preferably carried out as a video poker game for an individual player, the gaming device 72 is, in various embodiments, also linked and/or connected to one or more additional gaming devices 72 for enhanced play, such as enabling collective and/or progressive jackpots therebetween. In various embodiments, such multiple gaming devices 72 are located in a same or different location(s).

For at least any or all of the above, including, for example, at least the card shuffler 26, card shoe 28, display/input interface 100, data entry input 50, control processor 52, game display 54, communications network 56, video device 58, dealer screen 60, card screen 64, gaming device 72, gaming screen 74, and/or the like. Standard protocols known in the art are preferred, including for software, hardware, firmware, communicationware, cloudware, and/or the like, and/or in various combinations thereof, including any computer languages, programs, operating systems, memory storage devices, data processors, and/or network communication devices that readily enable access to the inventive arrangements, particularly as a chosen matter of suitable design choice by those skilled in such arts. As one such example, memory storage devices store programs and/or instructions, executable by the control processor 52, to control the applicable gaming platforms, and control processer functionality is implemented in one or more control processors 52 acting individually and/or collectively across the gaming platforms.

More specifically, when the inventive arrangements are implemented on a table 10, the dealer position 12 is in generally opposite relation to the one or more player positions 14. On the other hand, when the inventive arrangements are implemented on a video device 58, the functionality of the dealer position 12 is carried out by the control processor 52 acting in conjunction with the video device 58. Likewise, when the inventive arrangements are implemented on a gaming device 72, the functionality of the dealer position 12 is carried out by the control processor 52 acting in conjunction with the gaming device 72. In these instances, the functionality of game play between the dealer (live or control processor based) and player is relatively proximate. On the other hand, in other alternative embodiments, the functionality of game play between the dealer (specifically, control processor based) and player is relatively distant.

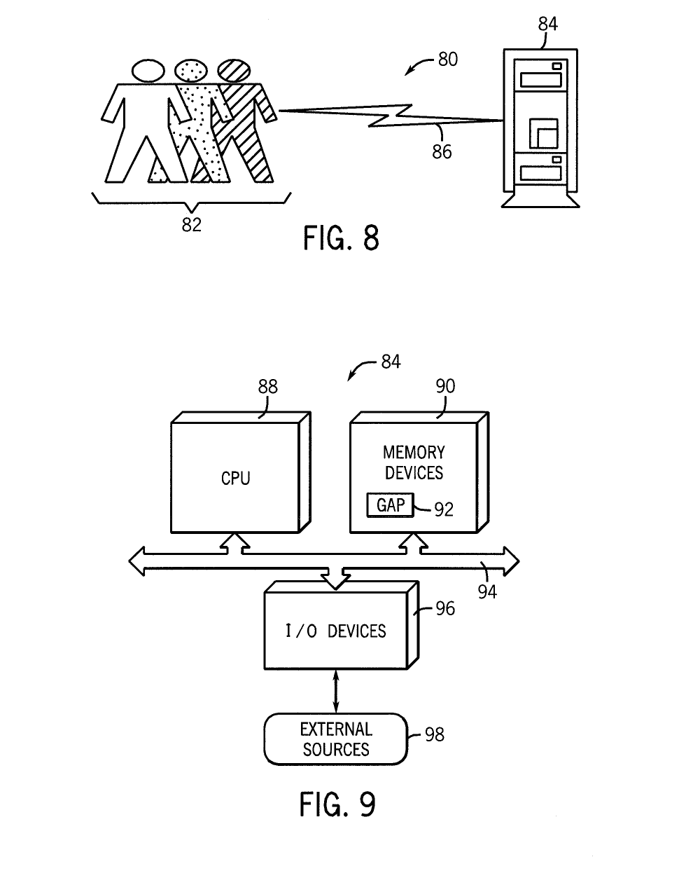

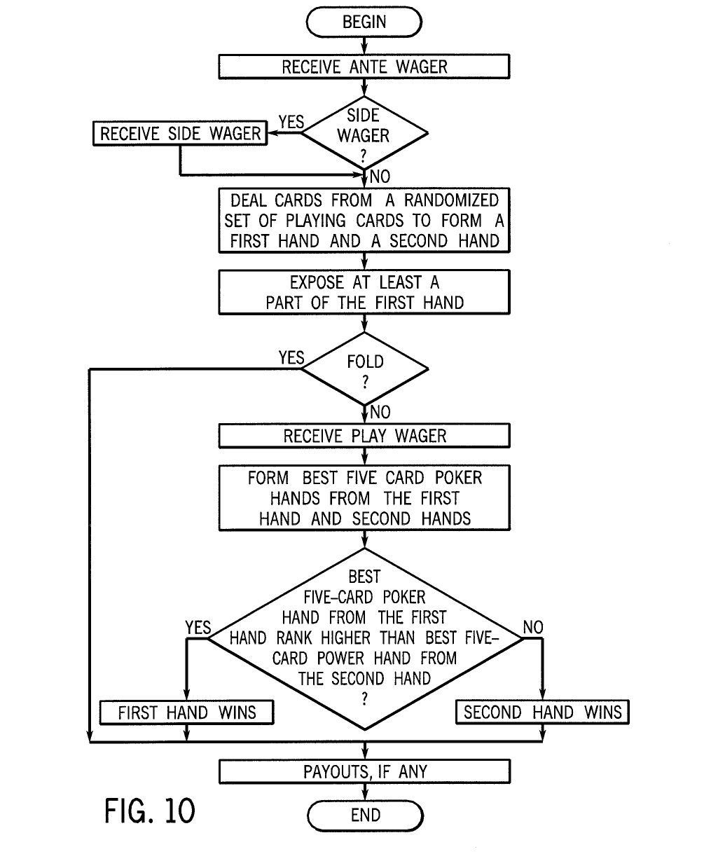

More specifically, and referring to FIG. 8, a simplified schematic view of a gaming network 80 is depicted in which preferred embodiments of the inventive arrangements are practiced. More specifically, players 82 interact with a computer system 84 through a computer network 86. The players 82 and computer system 84 are physically remote from one another, operatively connected through the computer network 86.

Referring now even more specifically to FIG. 9, the inventive arrangements are preferably implemented on a computer system 84 comprising a central processing unit (CPU) 88 and one or more memory devices 90. Typically, the memory devices 90 include volatile memory (not shown), such as random access memory (RAM), and non-volatile memory (not shown), such as a hard-disk drive or other fixed-storage memory device. The non-volatile memory, which preferably includes read-only memory (ROM), stores therein an operating system (not shown) and one or more application programs, such as a gaming application program (GAP) 92 that enables the inventive arrangements. In alternative embodiments, one or more application programs, including the GAP 92, is stored in a removable memory device (not shown), such as, for example, a floppy disk, optical disc for use, for example, with a CD-ROM, and/or other. In either event, the CPU 88 and memory devices 90 are suitable devices known to those skilled in the art, wherein, for example, the operating system is conventionally loaded from the non-volatile memory into the volatile memory during bootstrapping of the computer system 84 and then executed. Subsequently, the operating system then conventionally loads the GAP 92 from the non-volatile memory into the volatile memory for execution. Upon the loading thereof, the CPU 88 then executes the GAP 92. More specifically, the CPU 88 executes one or more programmed code sections that comprise the GAP 92 in order to perform various operations according to the inventive arrangements. Each programmed code section thus includes instructions that are executed by the CPU 88. As such, the inventive arrangements of the GAP 92 are carried out by the computer system 84.

In operation of the preferred embodiment shown in FIG. 9, the CPU 88 and memory devices 90 communicate through a conventional bus 94, which additionally interfaces with one or more input/output (“I/O”) devices 96 also operatively connected thereto. The I/O devices 96 allow the players 82 to communicate with the GAP 92 of the computer system 84, such as, for example, through one or more external sources 98 operating over the computer network 86. Accordingly, for example, the computer network 86 enables game play over, for example, the internet (or other) and/or at, or on, one or more of the following external sources 98: computers, personal computers, networked computers, desktop computers, laptops, notebooks, netbooks, tablets, tablet computers, pads, pad computers, electronic pads, readers, electronic readers, hand-held devices, wireless devices, web devices, web-sites, palm tops, palm pilots, pocket computers, pocket-sized computers, portable consoles, game consoles, portable game consoles, play stations, gaming devices, mobile devices, personal mobile devices, personal information managers, personal digital assistants (PDAs), beepers, pagers, phones, mobile phones, cell phones, smart phones, televisions, kiosks, scorecards, scoreboards, and/or the like—such as, for example, by software, programming applications, downloadable instructions, and/or the like in combination with appropriate hardware.

Alternatively, one skilled in the art will recognize that, in various embodiments, the inventive arrangements are realized in software, hardware, firmware, communicationware cloudware, and/or the like, and/or in various combinations thereof. In one embodiment, a representative visualization tool according to the inventive arrangements is realized in a centralized fashion over one computer system 84, or, alternatively, in a distributed fashion in which multiple elements and components are spread over multiple, interconnected computer systems 84. Moreover, any kind of computer system 84, or other apparatus, adapted for carrying out the inventive arrangements described herein is suited. One typical combination of hardware and software, for example, is a general purpose computer system 84 with a computer program that, upon loading and execution, controls the computer system 84 such that the inventive arrangements described herein are carried out. In various embodiments, the inventive arrangements are also embedded in a computer program product comprising the features of an enabling implementation of the inventive arrangements described herein, and which, upon being loaded and executed by the computer system 84, thus carries out the inventive arrangements.

In still other embodiments (not particularly shown), the inventive arrangements are implemented at, or on, one or more of the following: parlor games; game boards; studio game shows; television game shows; cable television shows, and/or lottery tickets, such as scratch-off lottery tickets. Such adaptions are readily carried out as a chosen matter of suitable design choice by those skilled in such arts.

In accordance with the foregoing, one technical effect is enhanced card play, and more specifically, an inventive poker variety thereof according to the inventive arrangements.

Accordingly, it should be readily apparent that this specification describes illustrative, exemplary, representative, and non-limiting embodiments of the inventive arrangements. Accordingly, the scope of the inventive arrangements is not limited to any of these embodiments. Rather, various details and features of the embodiments were disclosed as required. Thus, many changes and modifications, as readily apparent to those skilled in these arts, are within the scope of the inventive arrangements without departing from the spirit hereof, and the inventive arrangements are inclusive thereof. Accordingly, to apprise the public of the scope and spirit of the inventive arrangements, the following claims are made:

1-26. (canceled)

27. A method of managing play of a wagering game at a game table with at least one player, comprising:
accepting placement of an ante wager at a player position on the game table by the at least one player to participate in the wagering game;
dealing a selected number of randomized physical playing cards from a set of physical playing cards to the at least one player at the player position on the game table;
dealing to a dealer at a dealer position on the game table a selected number of randomized physical playing cards from the set of physical playing cards equal to the selected number of physical playing cards dealt to the at least one player;
revealing a portion of the selected number of physical playing cards dealt to the dealer to the at least one player;
allowing the at least one player to view the selected number of physical playing cards dealt to the at least one player;
accepting a play wager from the at least one player to continue play of the wagering game against the dealer;
revealing a remaining portion of the selected number of physical playing cards dealt to the dealer to the at least one player;
qualifying the selected number of physical playing cards dealt to the dealer comprising:
returning the ante wager to the at least one player and maintaining the play wager in the wagering game if the selected number of physical playing cards dealt to the dealer does not contain a selected ranking of physical playing cards; and
maintaining the ante wager and the play wager if the selected number of physical playing cards dealt to the dealer does contain the selected ranking of physical playing cards;
determining a best poker hand for the at least one player from the selected number of physical playing cards dealt to the at least one player;
determining a best poker hand for the dealer from the selected number of physical playing cards dealt to the dealer; and
resolving the ante wager and the play wager by comparing a poker ranking of the best player hand to a poker ranking of the best dealer hand comprising:
awarding a payout of the ante wager and the play wager to the at least one player if the best poker hand of the at least one player is better than the best poker hand of the dealer according to the poker hand hierarchy;
taking the ante wager and the play wager if the best poker hand of the dealer is better than the best poker hand of the at least one player according to a poker hand hierarchy; and
returning the ante wager and the play wager to the at least one player if the best poker hand of the at least one player is the same as the best poker hand of the dealer according to the poker hand hierarchy.

28. The method of claim 27, further comprising selecting the selected number of physical playing cards dealt to the at least one player and the dealer to comprise six physical playing cards and the portion of the selected number of physical playing cards dealt to the dealer that are revealed to the at least one player to comprise three physical playing cards.

29. The method of claim 28, wherein determining a best poker hand for the at least one player comprises selecting a best five-card poker hand from the six physical playing cards dealt to the at least one player and wherein determining a best poker hand for the dealer comprises selecting a best five-card poker hand from the six physical playing cards dealt to the dealer.

30. The method of claim 28, wherein revealing a portion of the selected number of physical playing cards dealt to the dealer to the at least one player comprises selecting the last three physical playing cards of the six physical playing cards dealt to the dealer to reveal to the at least one player.

31. The method of claim 27, further comprising requiring the play wager to be a multiple of the ante wager.

32. The method of claim 27, further comprising requiring the play wager to be one times the ante wager.

33. The method of claim 27, further comprising requiring the play wager to be two or more times the ante wager.

34. The method of claim 27, wherein qualifying the selected number of physical playing cards dealt to the dealer further comprises requiring the best poker hand dealt to the dealer to contain the selected ranking of physical playing cards.

35. The method of claim 27, further comprising requiring the selected ranking of physical playing cards dealt to the dealer to comprise at least one playing card having the rank of ace and at least one playing card having the rank of king.

36. The method of claim 27, wherein awarding a payout of the ante wager and the play wager to the at least one player if the best poker hand of the at least one player is better than the best poker hand of the dealer according to the poker hand hierarchy comprises paying the at least one player 1:1 on the ante wager and on the play wager.

37. The method of claim 27, further comprising supplying the physical playing cards of the set of physical playing cards from at least one of a mechanical shuffler and a card shoe.

38. The method of claim 27, enabling the at least one player to place at least one electronic wager on a chipless computer interface at the player position on the game table.

39. The method of claim 27, further comprising enabling the at least one player to place a side wager at the player position on the game table.

40. The method of claim 39, wherein enabling the at least one player to place a side wager comprises requiring that the side wager is placed before dealing any physical playing cards from the set of physical playing cards.

41. The method of claim 39, further comprising paying the side wager according to a pay table based on the best poker hand of the at least one player regardless of whether the at least one player has made the play wager and regardless of whether the best poker hand of the dealer is better than, equal to, or less than the best poker hand of the at least one player according to a poker hand hierarchy.

42. The method of claim 39, wherein enabling the at least one player to place a side wager comprises requiring the at least one player to place the side wager.

43. A method of managing play of a wagering game at a game table with at least one player, comprising:
accepting placement of an ante wager at a player position on the game table by the at least one player to participate in the wagering game;
dealing six randomized physical playing cards from a set of physical playing cards to the at least one player at the player position on the game table;
dealing to a dealer at a dealer position on the game table six randomized physical playing cards from the set of physical playing cards equal to the selected number of physical playing cards dealt to the at least one player;
revealing three of the six physical playing cards dealt to the dealer to the at least one player;
allowing the at least one player to view the six physical playing cards dealt to the at least one player;
accepting a play wager from the at least one player to continue play of the wagering game against the dealer;
revealing the remaining three physical playing cards dealt to the dealer to the at least one player;
determining a best poker hand for the at least one player from the six physical playing cards dealt to the at least one player;
determining a best poker hand for the dealer from the six physical playing cards dealt to the dealer;
qualifying the best poker hand of the dealer comprising:
returning the ante wager to the at least one player and maintaining the play wager in the wagering game if the selected number of physical playing cards dealt to the dealer does not contain a selected ranking of physical playing cards; and
maintaining the ante wager and the play wager if the selected number of physical playing cards dealt to the dealer does contain the selected ranking of physical playing cards; and
resolving the ante wager and the play wager by comparing a poker ranking of the best player hand to a poker ranking of the best dealer hand comprising:
awarding a payout of the ante wager and the play wager to the at least one player if the best poker hand of the at least one player is better than the best poker hand of the dealer according to the poker hand hierarchy;
taking the ante wager and the play wager if the best poker hand of the dealer is better than the best poker hand of the at least one player according to a poker hand hierarchy; and
returning the ante wager and the play wager to the at least one player if the best poker hand of the at least one player is the same as the best poker hand of the dealer according to the poker hand hierarchy.

44. A system comprising:
at least one input interface;
at least one display;
at least one processor; and
a device-readable, non-transitory storage medium containing device-executable code when executed by the at least one processor for managing play of a wagering game with at least one player comprising:
accepting placement of an ante wager by the at least one player with the at least one input device to participate in the wagering game;
displaying with the at least one display a virtual player card set comprising a selected number of randomized virtual playing cards from a set of virtual playing cards to the at least one player;
allocating to a virtual dealer card set a selected number of randomized virtual playing cards from the set of virtual playing cards equal to the selected number of virtual playing cards displayed to the at least one player;
displaying with the at least one display a portion of the selected number of physical playing cards from the virtual dealer card set to the at least one player;
accepting a play wager with the at least one input device to continue play of the wagering game against the virtual dealer;
displaying with the at least one display a remaining portion of the selected number of physical playing cards from the virtual dealer card set to the at least one player;
determining a best poker hand for the at least one player from the virtual player card set;
determining a best poker hand for a virtual dealer from the virtual dealer card set;
qualifying the best poker hand of the virtual dealer comprising:
returning the ante wager to the at least one player and maintaining the play wager in the wagering game if the selected number of physical playing cards dealt to the virtual dealer does not contain a selected ranking of physical playing cards; and
maintaining the ante wager and the play wager if the selected number of physical playing cards dealt to the virtual dealer does contain the selected ranking of physical playing cards;
displaying with the at least one display the best poker hand for the at least one player and the best poker hand for the virtual dealer to the at least one player;
resolving the ante wager and the play wager by comparing a poker ranking of the best player hand to a poker ranking of the best dealer hand and displaying the results to the at least one player with the at least one display comprising:
awarding a payout of the ante wager and the play wager to the at least one player if the best poker hand of the at least one player is better than the best poker hand of the dealer according to the poker hand hierarchy;
taking the ante wager and the play wager if the best poker hand of the dealer is better than the best poker hand of the at least one player according to a poker hand hierarchy; and
returning the ante wager and the play wager to the at least one player if the best poker hand of the at least one player is the same as the best poker hand of the dealer according to the poker hand hierarchy.

45. The system of claim 44, wherein the device-executable code further requires selecting the virtual player card set to comprise six physical playing cards, the virtual dealer card set to comprise six physical playing cards, and the portion of the selected number of physical playing cards from the virtual dealer card set that are revealed to the at least one player to comprise three physical playing cards.
